(19) United States
(12) Patent Application Publication
(10) Pub. No.: US 2009/0044682 A1
(43) Pub. Date: Feb. 19, 2009

(54) Method and system for collectable piano replicas having autographed piano keys

(76) Inventors: David Paul Kobe, Phoenix, AZ (US); Debra Susan Russell, Phoenix, AZ (US)

Correspondence Address: Matthew P. Schmehl, 1326 East Secretariat Dr, Tempe, AZ, 85284, US

(21) Appl. No.: 12/154,533

(22) Filed: May 24, 2008

Related U.S. Application Data
(60) Provisional application No. 60/940,077, filed on May 25, 2007.

(51) Int. Cl. G10C 3/00

(52) U.S. Cl. 84/174

(57) ABSTRACT

This invention provides an apparatus comprising small-scale piano replicas having autographed piano keys integral to the collectable and method therefore. Additionally, a method of creating collectable piano replicas comprising actual piano keys that are signed or autographed by an artist, or artists, the autographed piano keys being integral to the piano replica thereby producing a musical collectable.

This application claims the benefit of U.S. Provisional Application No. 60/940,077, filed May 25, 2007 and which is incorporated by reference in its entirety herein for all purposes.

### FIELD OF THE INVENTION

The present invention relates to collectables and methods for creating them, specifically a method and system for collectable piano replicas having autographed piano keys.

### BACKGROUND OF THE INVENTION

The field of collectables includes many types of items ranging from photographs of famous people to the automobiles owned by famous people, and to the musical instruments played by famous people. An item generally becomes more valuable and desirable as a collectable if it has been signed, or autographed, by the famous person, or persons, related to that particular item. In regard to musical instruments, it is relatively easy to have a famous guitar artist sign a guitar because a guitar is a relatively inexpensive instrument, and a guitar is also of a size that can be easily transported and easily displayed. However, when the subject artists play other instruments, such as pianos, many obstacles arise. Pianos, particularly grand pianos are very expensive instruments, and are also very large instruments. Few people desiring to obtain collectables have the available financial resources or the available floor space to store and display a piano, grand or otherwise. The artist also faces these same obstacles in attempting to create collectables. Additionally, some people and organizations are desirous of creating collectables to be sold or auctioned off, in many cases for charitable fund raising purposes. Therefore, the above obstacles also affect these people and organizations who may not have the financial resources to purchase grand pianos, and also surmount the attendant difficulties of transporting and storing pianos through the cycle of purchase, artist signature, sale, etc. Therefore, a need existed to create a system and method of creating collectables overcoming the above obstacles relative to size and expense.

### SUMMARY OF THE INVENTION

One object of the present invention is to provide a system and a method for creating collectable piano replicas having autographed piano keys integral to the collectable wherein the piano replica is of a size and shape to overcome the obstacles of expense and size.

Another object of the present invention is to provide a system or method of creating collectable piano replicas comprising actual piano keys that are signed or autographed by an artist, or artists, the autographed piano keys being integral to the piano replica thereby creating a musical collectable.

A further object of the present invention is to provide collectable piano replicas comprising actual piano keys that are signed or autographed by an artist, or artists, the autographed piano keys being integral to the piano replica.

Yet a further object of the present invention is to provide a method of creating collectable piano replicas providing steps whereby an artist, or artists signs, or autographs, actual piano keys, such then being placed integral to the piano replica thereby creating a collectable that possess an actual musical connection to the artist or artists.

### BRIEF DESCRIPTION OF THE DRAWINGS

FIG. 1 is a perspective view of a preferred embodiment of the present invention showing a small-scale grand piano replica having a section of autographed piano keys integral thereto, and also featuring a display stand.

FIG. 2 is a perspective view of another preferred embodiment of the present invention showing a small-scale grand piano replica having a section of autographed piano keys integral thereto, wherein the replica sits upon legs in the manner of a full-size grand piano.

FIG. 3 is an exploded view of the small-scale grand piano replica of FIGS. 1 and 2.

FIG. 4 is a depiction of a standard piano keyboard, which forms the source of the piano keys shown in FIGS. 1 & 2.

FIG. 5 is a perspective drawing of another preferred embodiment of the present invention showing a small-scale upright piano replica having a section of autographed piano keys integral thereto.

FIG. 6 is an exploded view of the small-scale upright piano replica of FIG. 5

FIG. 7 is a functional block diagram of an optional music system integral to the embodiments of the present invention.

### DETAILED DESCRIPTION OF THE INVENTION

An embodiment of the present invention comprises an apparatus comprising piano replicas having autographed piano keys integral to the collectable wherein the piano replica is of a size and shape, as will be explained below, to overcome the obstacles of expense and size relative to full size pianos. Additionally, as is described below, an embodiment of the present invention is a method of creating collectable piano replicas comprising actual piano keys that are signed or autographed by an artist, or artists, the autographed piano keys being integral to the piano replica thereby producing a musical collectable.

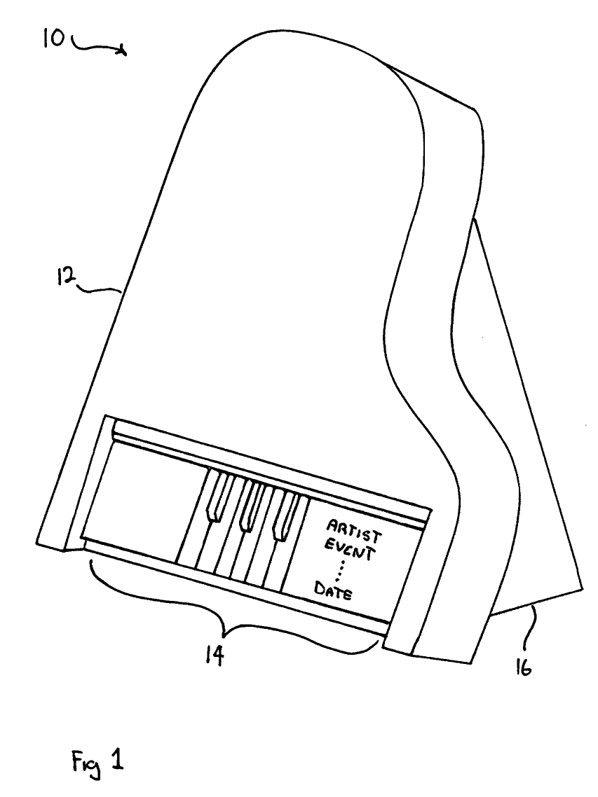

With reference now to FIGS. 1-7, the components and steps comprising preferred embodiments of the present invention are presented and explained as follows. With reference to FIG. 1, a perspective view of a preferred embodiment of the present invention showing a small-scale grand piano replica 10 is shown. The small-scale grand piano replica 10 comprises a grand piano replica body 12 having an autographed piano key insert 14 coupled thereto, and further having a display stand 16 coupled to the piano replica body 12, and which positions the grand piano replica body 12 in a favorable position for display and viewing. The small-scale grand piano replica 10 is representative of either a concert grand piano or a baby grand piano. The actual size and dimensions of the small-scale grand piano replica 10 is variable as the main requirement and feature is that upon viewing by an average person, the recognition of a grand piano occurs. Another factor affecting the size and dimensions of the small-scale grand piano replica 10 will be the number of autographed piano keys integral to the autographed piano key insert 14. In a preferred embodiment, the grand piano replica body 12 and the display stand 16 will be manufactured from wood and will have a high gloss finish applied thereto, similar in appearance to the finish found on full size grand pianos. The color of the finish may be black, or white, or any color or pattern as desired. In alternative embodiments however, the grand piano replica body 12 and the display stand 16 may be manufactured from other materials, or combinations of materials, such as plastics, polycarbonates, metals, etc. as those skilled in the art will understand.

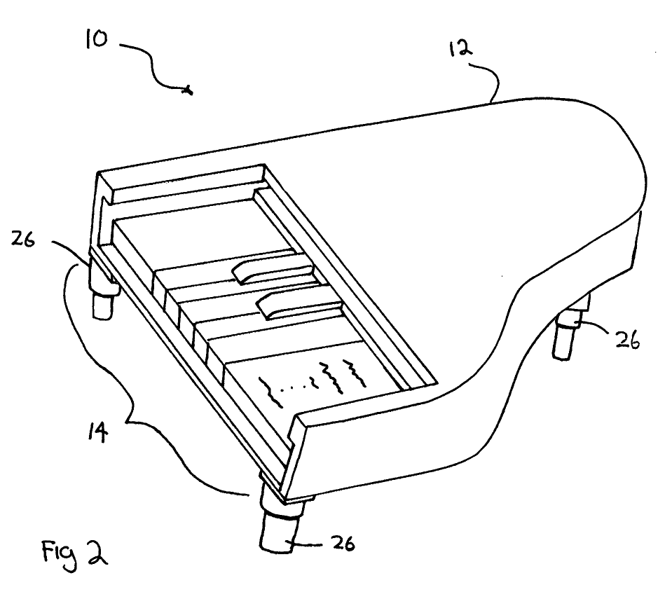

With reference to FIG. 2, a perspective view of a preferred embodiment of the present invention showing a small-scale grand piano replica 10 is shown. This embodiment of the small-scale grand piano replica 10 again comprises a grand piano replica body 12 having an autographed piano key insert 14. In this alternate embodiment however, the small-scale grand piano replica 10 further comprises a set of support legs 26 coupled to the underside of the small-scale grand piano replica 10. The support legs 26 enable the small-scale grand piano replica 10 to be displayed on a flat surface in a manner more closely resembling a full size grand piano. As previously explained, the small-scale grand piano replica 10 is representative of either a concert grand piano or a baby grand piano and the previous explanations regarding size, dimensions and materials is equally applicable to this embodiment including the support legs 26.

It should also be noted that, although not shown herein, spinet pianos of the type known as harpsichords would also fall within the description of the above grand pianos and the above explanations and descriptions would be applicable thereto, a small-scale harpsichord piano thus representing another embodiment of the present invention.

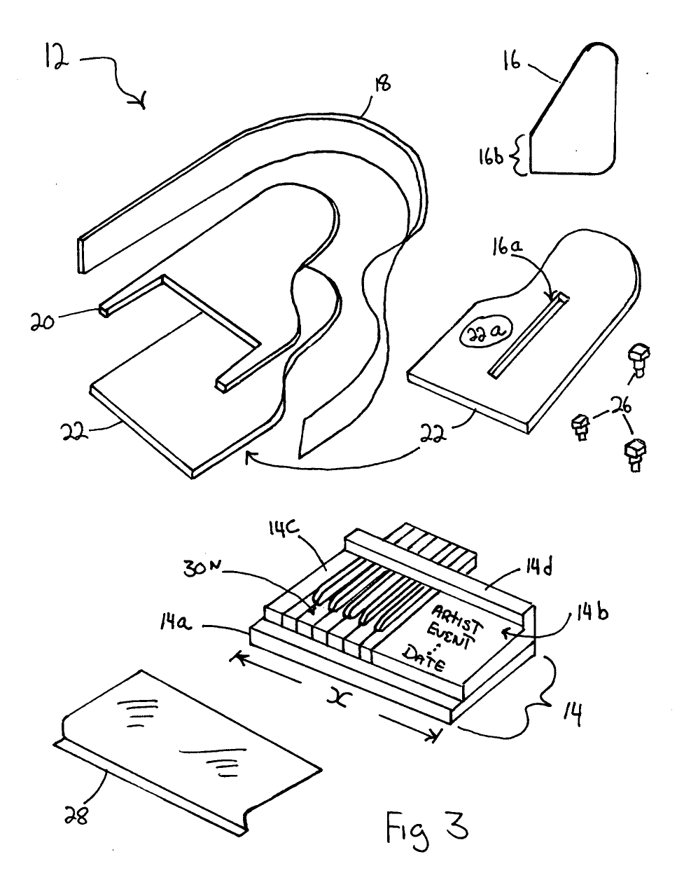

With reference to FIG. 3, an exploded view of the small-scale grand piano replica 10 of FIG. 1 and FIG. 2 is shown. The grand piano replica body 12 comprises: a grand piano top 20, a grand piano side wrap around 18, and a grand piano bottom 22. These items are coupled together using an adhesive or mechanical fastening as is well known to those skilled in the art. Also shown is the grand piano bottom 22 in an inverted position. The outer side 22a of the grand piano bottom 22 further comprises a groove, or slot, 16a manufactured into the outer side 22a. The slot 16a couples to the edge 16b of the display stand 16. The mechanical coupling between the slot 16a couples to the edge 16b is accomplished using either an adhesive and/or mechanical fasteners in a manner well known to those skilled in the art. Also shown on FIG. 3 are the support legs 26. The support legs 26 couple to the outer side 22a using either an adhesive and/or mechanical fasteners in a manner well known to those skilled in the art.

With further reference to FIG. 3, the autographed piano key insert 14 is shown. The autographed piano key insert 14 is coupled to the grand piano replica body 12 and fastened thereto either with an adhesive or mechanically fastened. The autographed piano key insert 14 comprises a keyboard insert base 14a. Coupled to the keyboard insert base 14a is a keyboard insert event commemoration plaque 14b, an autographed keys spacer 14c, and a spacer element 14d. Coupled between the keyboard insert event commemoration plaque 14b and the autographed keys spacer 14c is an autographed piano key set 30n.

The autographed piano key set 30n is the means and apparatus upon which the artist or artists place their signatures to enable the method and system for collectable piano replicas having autographed piano keys. The autographed piano key set 30n represents at least one piano key having at least one signature thereon from an artist or artistic group.

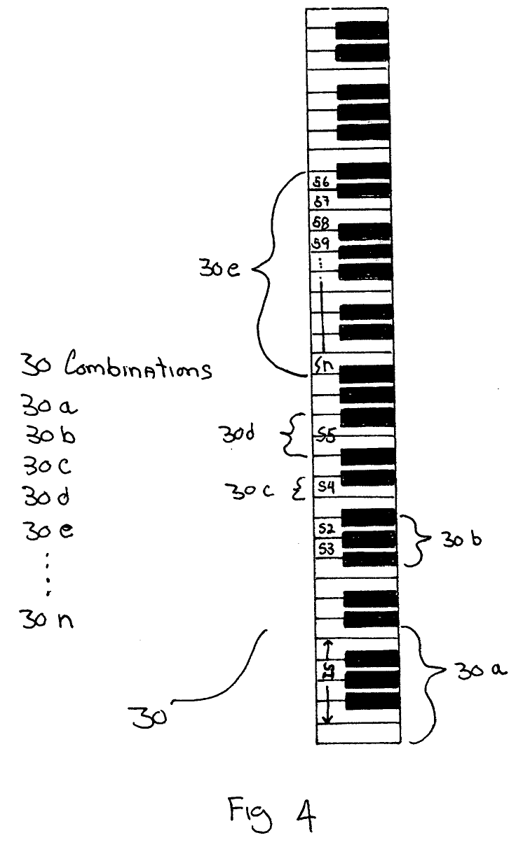

Referring to FIG. 4, a depiction of a standard 88 key piano keyboard 30 is shown. The 88 key piano keyboard 30 provides a means of capturing a plurality of artist signatures without incurring the expense and logistics obstacles attendant in purchasing a full size piano for every artist. The keyboard 30 further provides a system and means for capturing artist's signatures upon the key or keys thus resulting in the autographed piano keys which form an integral part of the system and method for collectable piano replicas having autographed piano keys, which forms the source of the piano keys shown in FIGS. 1 & 2. A standard length 88 key keyboard 30 provides opportunity for at least 88 different artists, or groups, to place signatures upon the keys of keyboard 30. Several examples relative to signing piano keys are shown in FIG. 4.

The keyboard section 30a is a keyboard section having 9 keys, of which 6 may be signed in a dark or contrasting color, and 3 keys which may be signed using a light or contrasting color. The notation S1 is representative of a signature that runs perpendicular to the length of the keys traversing a plurality of keys. The signature of the artist or artists may be obtained using one of various steps as follows: 1) The artist, or artists may choose to donate their signature(s) freely without remuneration. Or, 2) The artist, or artists may be compensated, possibly under a contract, for their signatures. The actual placement of the artist, or artists, signatures is as described above, and below.

In yet another example, keyboard section 30b is a keyboard section having 5 keys, of which 2 may be signed in a dark or contrasting color, and 3 keys which may be signed using a light or contrasting color. The notations S2 and S3 are representative of signatures that are only upon a single key. In yet another example, keyboard section 30c is a keyboard section having only 1 key, which may be signed in a dark or contrasting color. The notation S4 is representative of a signature only upon a single key. In yet another example, keyboard section 30c is a keyboard section having 5 keys, of which 2 may be signed in a dark or contrasting color, and 3 keys which may be signed using a light or contrasting color. The notations S2 and S3 are representative of signatures that are only upon a single key. In yet another example, keyboard section 30d is a keyboard section having 2 keys, which may be signed in a dark or contrasting color. The notation S5 is representative of a single signature that covers both of the keys of section 30d. In yet another example, keyboard section 30e is a keyboard section having a plurality of keys light and dark keys which may be signed in a contrasting color. The notations S6, S7, S8, S9 thru Sn are representative of signatures that are only upon a key or keys. In a further example, combinations of artists signatures may be placed upon the keys by combining S1 with S5 for example. In this case, the artists of a group would sign individual keys such as explained for S5, and then the group's name would be placed as in S1 traversing a plurality of keys. It should be noted that a group may be referred to as an “artist” even though the group may have multiple individuals. Also, although not explicitly shown, as previously mentioned, signatures may also appear on the black keys using a contrasting color or by using white.

An important feature here in all embodiments of the present invention is that any combination of the piano keys from the keyboard 30 may be used to capture artist signatures in any fashion or combination. Additionally, it should be recognized that it is not necessary to actually purchase a full size piano, or even a full size piano keyboard in order to obtain piano keys suitable for use in preferred embodiments of the present invention. The piano keys may be procured from a variety of sources including new stock from a supply source, or used keys originating in used pianos, or keys that were previously removed from pianos.

With reference back to FIG. 3, an autographed piano key set 30n section having a desired number of keys (e.g. a selection such as 30a, 30b, 30c, etc) is placed upon the keyboard insert base 14a and coupled thereto. The keyboard insert event commemoration plaque 14b and an autographed keys spacer 14c are sized such that the combined length of them and the autographed piano key set 30n form the exact width of the keyboard insert base 14a, dimension x. The keyboard insert base 14a, is mechanically joined to the keyboard insert event commemoration plaque 14b, the autographed piano key set 30n and the autographed keys spacer 14c using adhesive or mechanical means well known to those skilled in the arts. Placed atop the rear edge of the combination of: the keyboard insert event commemoration plaque 14b, the autographed keys spacer 14c and the autographed piano key set 30n, is a spacer element 14d which serves to provide a spacer between the tops of these items and the bottom of the grand piano top 20. The autographed piano key insert 14 is next inserted into the open end of the grand piano replica body 12 as depicted in FIGS. 1 and 2.

The keyboard insert event commemoration plaque 14b is used to memorialize the details surrounding the artist, or artists autographing the keys of the keyboard autographed piano key set 30n. Examples of information that may be placed upon the keyboard insert event commemoration plaque 14b include the date, the event, the venue, the artists names, etc. The information may be engraved, printed, or otherwise applied upon the keyboard insert event commemoration plaque 14b. Additionally, the information may be placed upon a separate plaque (not shown herein), which is in turn affixed upon the keyboard insert event commemoration plaque 14b.

A further feature shown in FIG. 3 is a clear protective cover 28 that is placed and affixed over the autographed piano key insert 14 section. The clear protective cover 28 may be plastic, acrylic, glass, polycarbonate, etc. The clear protective cover 28 protects the autographed keys of the autographed piano key set 30n from the damaging effects of finger oils and grimes thereby enhancing the collectable value of embodiments of the present invention.

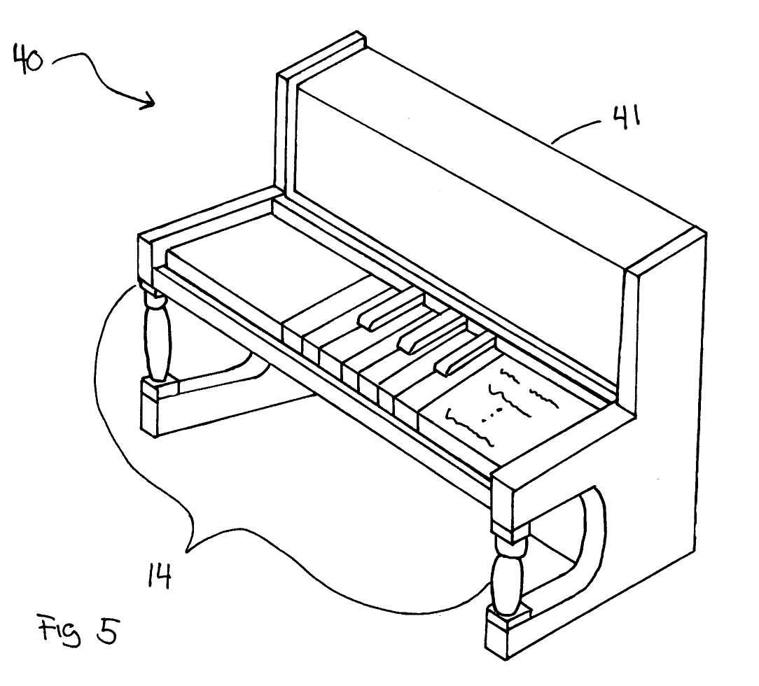

Referring now to FIG. 5, a perspective drawing of another preferred embodiment of the present invention, a small-scale upright piano replica 40 having a section of autographed piano keys integral thereto is shown. The small-scale upright piano replica 40 comprises a upright piano replica body 41 having an autographed piano key insert 14 coupled thereto. The small-scale upright piano replica 40 is representative of an upright, or vertical piano, also sometimes known as a spinet piano due to its smaller size.

The actual size and dimensions of the small-scale upright piano replica 40 is variable as the main requirement and feature is that upon viewing by an average person, the recognition of an upright piano occurs. Another factor affecting the size and dimensions of the small-scale upright piano replica 40 will be the number of autographed piano keys integral to the autographed piano key insert 14. In a preferred embodiment, the upright piano replica body 41 will be manufactured from wood and will have a high gloss finish applied thereto, similar in appearance to the finish found on full size upright pianos. The color of the finish may be brown, black, or white, or any color or pattern as desired. In alternative embodiments however, the upright piano replica body 41 may be manufactured from other materials, or combinations of materials, such as plastics, polycarbonates, metals, etc. as those skilled in the art will understand.

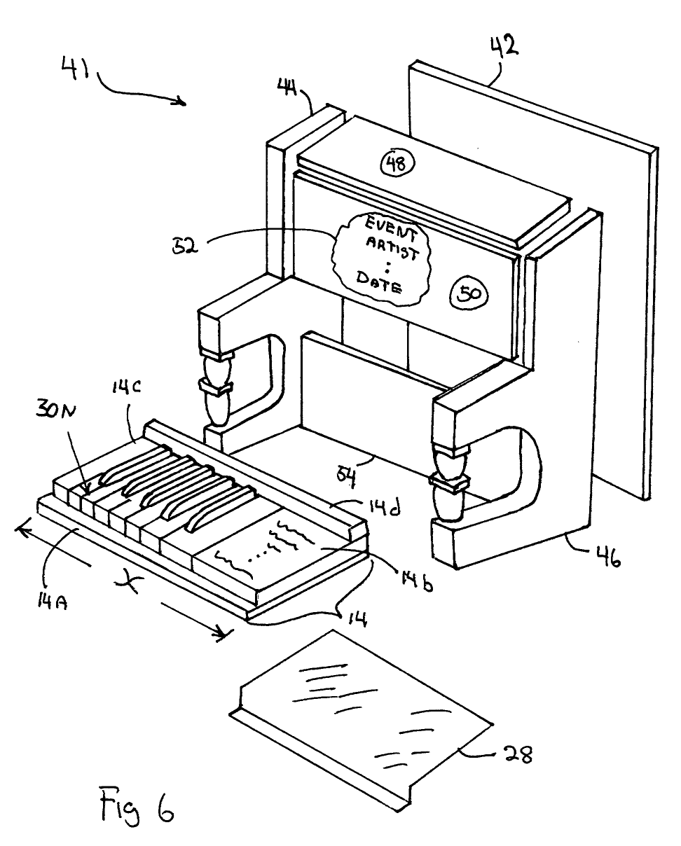

With reference to FIG. 6, an exploded view of the small-scale upright piano replica 40 of FIG. 5. The upright piano replica body 41 comprises: an upright piano top 48, an upright piano left side 44, an upright piano right side 46, an upright piano back 42, an upright piano front 50, and an upright piano kick panel 54. These items are coupled together using an adhesive or mechanical fastening as is well known to those skilled in the art. Note also that the vertical dimensions of the upright piano left side 44, the upright piano right side 46, the upright piano back 42, and the upright piano front 50 maybe increased or decreased in size during the manufacturing process to result in a upright piano replica body 41 that more closely resembles a normal height upright piano, or a spinet type upright piano.

With further reference to FIG. 6, the autographed piano key insert 14 is shown. The autographed piano key insert 14 is coupled to the upright piano replica body 41 and fastened thereto either with an adhesive or mechanically fastened. As previously explained, the autographed piano key insert 14 comprises a keyboard insert base 14a. Coupled to the keyboard insert base 14a is a keyboard insert event commemoration plaque 14b, an autographed keys spacer 14c, and a spacer element 14d. Coupled between the keyboard insert event commemoration plaque 14b and the autographed keys spacer 14c is an autographed piano key set 30n.

The autographed piano key set 30n is the means and apparatus upon which the artist or artists place their signatures to enable the method and system for collectable piano replicas having autographed piano keys. The autographed piano key set 30n represents at least one piano key having at least one signature thereon from an artist or artistic group.

As previously explained, with reference, to FIG. 4, a depiction of a standard 88 key piano keyboard 30 is shown. The 88 key piano keyboard 30 provides a means of capturing a plurality of artist signatures without incurring the expense and logistics obstacles attendant in purchasing a piano. The keyboard 30 provides a system and means for capturing artist's signatures upon the key or keys thus resulting in the autographed piano keys which form an integral part of the system and method for collectable piano replicas having autographed piano keys, which forms the source of the piano keys shown in FIG. 6. A standard length 88 key keyboard 30 provides opportunity for at least 88 different artists, or groups, to place signatures upon the keys of keyboard 30. Several examples are shown in FIG. 4.

The keyboard section 30a is a keyboard section having 9 keys, of which 6 may be signed in a dark or contrasting color, and 3 keys which may be signed using a light or contrasting color. The notation S1 is representative of a signature that runs perpendicular to the length of the keys traversing a plurality of keys. As previously explained, the signature of the artist or artists may be obtained using one of various steps as follows: 1) The artist, or artists may choose to donate their signature(s) freely without remuneration. Or, 2) The artist, or artists may be compensated, possibly under a contract, for their signatures. The actual placement of the artist, or artists, signatures is as described above, and below.

In yet another example, keyboard section 30b is a keyboard section having 5 keys, of which 2 may be signed in a dark or contrasting color, and 3 keys which may be signed using a light or contrasting color. The notations S2 and S3 are representative of signatures that are only upon a single key. In yet another example, keyboard section 30c is a keyboard section having only 1 key, which may be signed in a dark or contrasting color. The notation S4 is representative of a signature only upon a single key. In yet another example, keyboard section 30c is a keyboard section having 5 keys, of which 2 may be signed in a dark or contrasting color, and 3 keys which may be signed using a light or contrasting color. The notations S2 and S3 are representative of signatures that are only upon a single key. In yet another example, keyboard section 30d is a keyboard section having 2 keys, which may be signed in a dark or contrasting color. The notation S5 is representative of a single signature that covers both of the keys of section 30d. In yet another example, keyboard section 30e is a keyboard section having a plurality of keys light and dark keys that may be signed in a contrasting color. The notations S6, S7, S8, S9 thru Sn are representative of signatures that are only upon a key or keys. In a further example, combinations of artists signatures may be placed upon the keys by combining S1 with S5 for example. In this case, the artists of a group would sign individual keys such as explained for S5, and then the group's name would be placed as in S1 traversing a plurality of keys. It should be noted that a group may be referred to as an artist even though the group may have multiple individuals. Also, although not explicitly shown, as previously mentioned, signatures may also appear on the black keys using a contrasting color or by using white.

Again, an important feature here in all embodiments of the present invention is that any combination of the piano keys from the keyboard 30 may be used to capture artist signatures in any fashion or combination. Additionally, it should be recognized that it is not necessary to actually purchase a full size piano, or even a full size piano keyboard in order to obtain piano keys suitable for use in preferred embodiments of the present invention. The piano keys may be procured from a variety of sources including new stock from a supply source, or used keys originating in used pianos, or keys that were previously removed from pianos.

With reference back to FIG. 3, an autographed piano key set 30n section having a desired number of keys (e.g. a selection such as 30a, 30b, 30c, etc) is placed upon the keyboard insert base 14a and coupled thereto. The keyboard insert event commemoration plaque 14b and an autographed keys spacer 14c are sized such that the combined length of them and the autographed piano key set 30n form the exact width of the keyboard insert base 14a, dimension x. The keyboard insert base 14a, is mechanically joined to the keyboard insert event commemoration plaque 14b, the autographed piano key set 30n and the autographed keys spacer 14c using adhesive or mechanical means well known to those skilled in the arts. Placed atop the rear edge of the combination of: the keyboard insert event commemoration plaque 14b, the autographed keys spacer 14c and the autographed piano key set 30n, is a spacer element 14d which serves to provide a spacer between the tops of these items and the bottom edge of the upright piano front 50. The autographed piano key insert 14 is next inserted between the upright piano left side 44, and the upright piano right side 46 as shown in FIG. 5.

The keyboard insert event commemoration plaque 14b is used to memorialize the details surrounding the artist, or artists autographing the keys of the keyboard autographed piano key set 30n. Examples of information that may be placed upon the keyboard insert event commemoration plaque 14b include the date, the event, the venue, the artists names, etc. The information may be engraved, printed, or otherwise applied upon the keyboard insert event commemoration plaque 14b. Additionally, the information may be placed upon a separate plaque (not shown herein) that is in turn affixed upon the keyboard insert event commemoration plaque 14b. Additionally, it should be noted that, as an option in this embodiment, the upright piano front 50 may also serve as the location of the information previously described as being located on the keyboard insert event commemoration plaque 14b, in which case that element would be similar in appearance to the autographed keys spacer 14c. And, as previously explained, examples of information that may be placed upon the upright piano front 50 in this option include the date, the event, the venue, the artists names, etc. The information may be engraved, printed, or otherwise applied upon the upright piano front 50. Additionally, the information may be placed upon a separate plaque (not shown herein), which is in turn affixed upon the upright piano front 50.

A further feature shown in FIG. 6 is a clear protective cover 28 that is placed and affixed over the autographed piano key insert 14 section. The clear protective cover 28 may be plastic, acrylic, glass, polycarbonate, etc. The clear protective cover 28 protects the autographed keys of the autographed piano key set 30n from the damaging effects of finger oils and grimes thereby enhancing the collectable value of embodiments of the present invention.

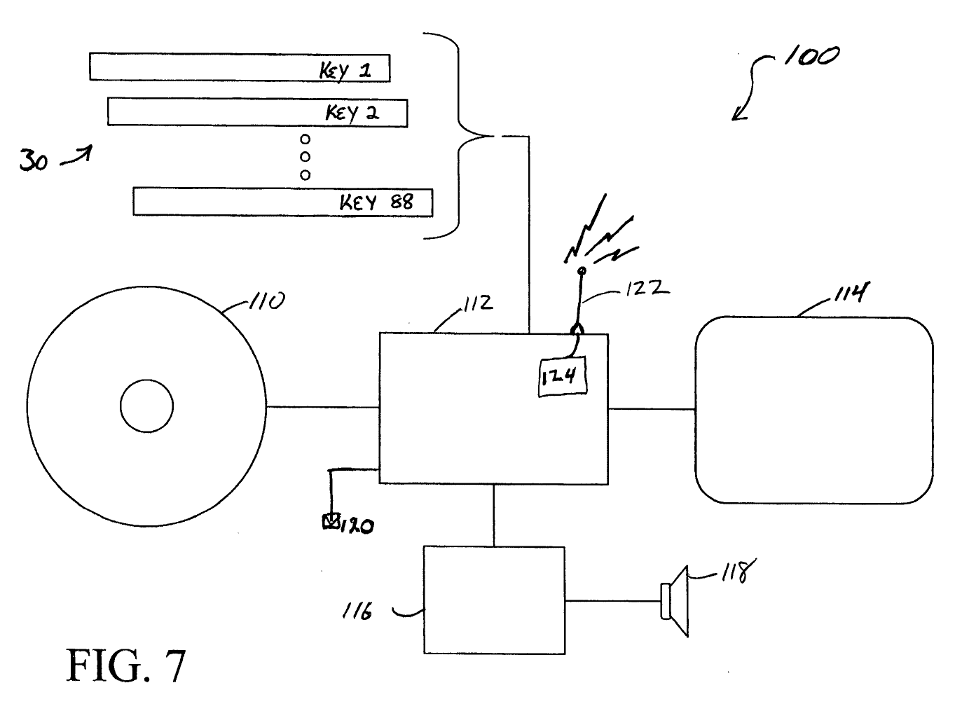

Referring now to FIG. 7, a functional block diagram of an optional music system integral to the embodiments of the present invention shown in FIGS. 1, 2, 3, 5, 6, is shown. The music system 100 is a system and method for coupling at least one piano key of the autographed piano key set 30n to a musical reproduction system. With reference to FIG. 7, a piano key (e.g. Key 1, Key 2, . . . Key 88) is coupled to a musical control module 112. The key coupled, in one preferred embodiment, will bear the signature of an artist or artists. When a user depresses the key, an actuation signal will be sent to the musical control module 112 to which it is coupled. The musical control module 112 is coupled to a compact disc music source 110, or alternatively to an electronic music storage module 114, or to both the compact disc music source 110, and to the electronic music storage module 114. The compact disc music source 110 is representative of a compact disc, of CD or DVD format, having the music of the artist or artists recorded thereon. The music may be a non-specific compilation of the artist's repertoire, but in a preferred embodiment may also be a musical selection or selections performed at the event memorialized on the keyboard insert event commemoration plaque 14b as previously described. Thus, when a user depresses at least one piano key of the autographed piano key set 30n, the musical control module 112 will activate the compact disc music source 110 and the selection or selections will be coupled from the compact disc music source 110 to the musical control module 112. The musical control module 112 is further coupled to an audio amplification system 116, which will amplify the selection or selections audio signal and produce an audio output via the speaker, or speakers 118 coupled to the audio amplification system 116. The audio amplification system 116 and the speaker 118 are at least one channel of audio processing and reproductive system, and may, as desired, be capable of stereo or other surround sound reproduction as is understood by those skilled in the art.

In one preferred embodiment the music system 100 is located integral to the small-scale grand piano replica 10, or integral to the small-scale upright piano replica 40. Additionally, in another preferred embodiment, the music system 100 will also optionally comprise an electronic coupling jack 120 to enable the user to couple the audio signal comprising the selection or selections to a user provided audio reproduction system. Further, in yet another option to the preferred embodiments, the music system 100 will further comprise a radio frequency (RF) transmission module 124 and antenna 122. The RF transmission module 124 and antenna 122 transmit an RF signal comprising the musical selection or selections present on the compact disc music source 110, or on the electronic music storage module 114. The electronic music storage module 114 may store the desired musical selection or selections in any of a variety of methods well known to those skilled in the art. E.g. mp3 format, analog, etc.

Having now created a collectable, or collectables, a holder of an embodiment of the present invention, or one practicing the steps of an embodiment of the present invention, may now sell, or auction off the small-scale grand piano replica 10 or the small-scale upright piano replica 40, as described above. Although, some may choose to trade or barter their small-scale grand piano replica 10 or small-scale upright piano replica 40 rather than directly selling or auctioning. Additionally, as with any collectable, holding such a collectable for a period of time may increase its worth.

The terms and expressions which have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims. It will doubtless be obvious to those of ordinary skill in the art that there are other embodiments employing these principles that are not described in detail herein.

I claim:

1) A collectable piano replica system, comprising:
a small scale piano replica;
at least one piano keyboard key coupled to said small scale piano replica; and
wherein said at least one piano keyboard key comprises an autograph by an artist.

2) The system of claim 1 wherein said artist is a single artist.

3) The system of claim 2 further comprising a commemoration plaque coupled to said small scale piano replica.

4) The system of claim 3 wherein said small scale piano replica is a small scale grand piano replica.

5) The system of claim 3 wherein said small scale piano replica is a small scale upright piano replica.

6) The system of claim 1 wherein said artist comprises multiple artists.

7) The system of claim 6 further comprising a commemoration plaque coupled to said small scale piano replica.

8) The system of claim 7 wherein said small scale piano replica is a small scale grand piano replica.

9) The system of claim 7 wherein said small scale piano replica is a small scale upright piano replica.

10) A collectable piano replica system, comprising:
a small scale piano replica;
at least one autographed piano keyboard key coupled to said small scale piano replica; and
a music system integral to said small scale piano replica.

11) The system of claim 10 wherein said music system comprises musical selections by the artist signing said at least one autographed piano keyboard key.

12) The system of claim 11 wherein said musical selections further comprise music recorded at an event proximate in time to said at least one autographed piano keyboard key being autographed by the performing artist.

13) The system of claim 11 further comprising a commemoration plaque coupled to said small scale piano replica, wherein said commemoration plaque comprises details of said event.

14) The system of claim 13 wherein said musical selections are integral to a compact disc removably placed within said small scale piano replica.

15) A method of creating collectable piano replicas comprising the steps of:
creating a small scale piano replica;
coupling to the small scale piano replica at least one piano key; and
having an artist place their autograph upon the at least one piano key.

16) The method of step 15 wherein the step of creating a small scale piano replica further comprises the step of coupling a music system integral to the small scale piano replica.

17) The method of claim 16 further comprising the step of placing music integral to the music system, wherein the music is recorded at an event proximate in time to said step of having an artist place their autograph upon the at least one piano key.

18) The method of claim 17 further comprising the step of conveying the small scale piano replica to a buyer for compensation.

19) The method of claim 16 further comprising the step of placing music integral to the music system upon a removable compact disc, wherein the music is recorded at an event proximate in time to said step of having an artist place their autograph upon the at least one piano key.

20) The method of claim 19 further comprising the step of conveying the small scale piano replica to a buyer for compensation.
